(19) United States
(12) Patent Application Publication
(10) Pub. No.: US 2025/0205529 A1
(43) Pub. Date: Jun. 26, 2025

(54) FIRE SUPPRESSION APPARATUSES, SYSTEMS, AND METHODS

(71) Applicant: InfernoShield Technology Solutions Inc., Yellowknife (CA)

(72) Inventor: Renee Melodie Gagnon, Cowichan Bay (CA)

(21) Appl. No.: 18/960,658

(22) Filed: Nov. 26, 2024

Related U.S. Application Data
(60) Provisional application No. 63/612,672, filed on Dec. 20, 2023.

(51) Int. Cl. A62C 35/02; A62C 3/02; A62C 35/13

(52) U.S. Cl. CPC A62C 35/026; A62C 3/0292; A62C 35/13

(57) ABSTRACT

Provided are apparatuses, systems and methods for fire suppression. The apparatus includes a securing means, a retardant container connected to the securing means for storing fire retardant, an agitation pump means, a delivery pump, an inlet of the delivery pump in communication with the fire retardant in the retardant container, wherein when activated, the delivery pump delivers pressurized fire retardant at an outlet of the delivery pump, an outlet pipe connected to the outlet of the delivery pump, and at least one spray head receiving the pressurized fire retardant from the outlet pipe and delivering fire retardant in a corresponding spray field. The system includes a network device, a fire retardant container, an activation means, a retardant distribution means, and a processor. The method provides a method of fire suppression and a method of installing a fire suppression apparatus.

### CROSS-REFERENCE TO RELATED APPLICATIONS

This application claims the benefit of U.S. Provisional Patent Application No. 63/612,672, filed Dec. 20, 2023, and the entire contents of U.S. Provisional Patent Application No. 63/612,672 is hereby incorporated by reference.

### FIELD

The present disclosure generally relates to apparatuses, methods and systems for fire suppression, and specifically, to apparatuses, methods and systems for forest fire suppression and protection of structures.

### INTRODUCTION

The following is not an admission that anything discussed below is part of the prior art or part of the common general knowledge of a person skilled in the art.

Forest fires devastate ecosystems by destroying trees, plants, and habitats. Often ignited by natural causes like lightning storms, or by the carelessness of human activity, forest fire can swiftly spiral out of control when fueled by dry conditions and strong winds. When left unchecked, forest fires have the potential to engulf vast expanses of woodland, causing irreparable damage to the ecosystem, air quality degradation, loss of biodiversity, and catastrophic consequences for both rural and urban communities.

To combat the ever-looming threat of forest fires, the implementation of fire suppression becomes increasingly paramount. These systems encompass a range of proactive measures, from early detection technologies to strategically placed firebreaks, and the deployment of firefighting teams. However, the unpredictability and ferocity of wildfires often outmatches even the quickest response teams. By the time a firefighting team can mobilize and deploy, a forest fire can spread and cause irreversible devastation.

The scale of forest fires means that often the only defense is controlling access to fuel in the form of other trees. However, due to the scale of wildfires including the speed at which they can move, their relative size, and problems related to access in remote communities, many structures are lost. Homeowners who stay to protect their homes put their lives at risk, and they do not have effective automated solutions for providing fire suppression.

Thus, there is a need for a system capable of proactive, remote fire suppression.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In one broad aspect, there is provided a fire suppression apparatus, the fire suppression apparatus comprising a securing means for securing the fire suppression apparatus in an outdoor environment; a retardant container connected to the securing means for storing fire retardant; an agitation pump means, the agitation pump providing agitation of the fire retardant within the retardant container; a delivery pump, an inlet of the delivery pump in communication with the fire retardant in the retardant container, wherein when activated, the delivery pump delivers pressurized fire retardant at an outlet of the delivery pump; an outlet pipe connected to the outlet of the delivery pump; and at least one spray head receiving the pressurized fire retardant from the outlet pipe and delivering fire retardant in a corresponding at least one spray field in the outdoor environment.

In at least one example embodiment, a first spray head in the at least one spray head may be connected to the outlet pipe, the first spray head having a first spray field, the first spray head may receive the pressurized fire retardant from the outlet pipe and may deliver fire retardant in the first spray field in the outdoor environment; and a second spray head in the at least one spray head may be connected to the outlet pipe, the second spray head may have a second spray field different from the first spray field, the second spray field may receive the pressurized fire retardant from the outlet pipe and may deliver fire retardant at the second spray field in the outdoor environment.

In at least one example embodiment, the delivery pump may be submerged in the fire retardant.

In at least one example embodiment, the fire suppression apparatus may further include an electrical storage means; and wherein the agitation pump and the delivery pump may be electric pumps powered by the electrical storage means.

In at least one example embodiment, the fire suppression apparatus may further include a solar panel for charging the electrical storage means.

In at least one example embodiment, the fire suppression apparatus may further include a remote device for activating the delivery pump.

In at least one example embodiment, the remote device may include a remote sensor.

In at least one example embodiment, the remote device may include a user device.

In at least one example embodiment, the first spray field may be relative to a radial direction of the outlet pipe and the second spray field may be relative to a length direction of the outlet pipe.

In at least one example embodiment, the first spray field may extend 360 degrees relative to the radial direction of the outlet pipe and the second spray field may extend 90 degrees relative to the length direction of the outlet pipe.

In at least one example embodiment, the first spray field may extend 180 degrees relative to the radial direction of the outlet pipe and the second spray field may extend 45 degrees relative to the length direction of the outlet pipe.

In at least one example embodiment, the first spray head and the second spray head may each include a user adjustment means operable by a user.

In at least one example embodiment, the user adjustment means may include a field adjustment means for adjusting the first spray field and the second spray field respectively.

In at least one example embodiment, the user adjustment means may include an angular adjustment means for adjusting the respective spray field by a spray angle.

In at least one example embodiment, the user adjustment means may include a flow rate adjustment means for adjusting the flow rate of the fire retardant into the first spray field and the second spray field respectively.

In at least one example embodiment, the fire retardant may be a mixture of water and fire retardant concentrate.

In at least one example embodiment, the fire retardant concentrate may be a mineral-based fire retardant.

In another broad aspect, there is provided a fire suppression system, the system including a network device for receiving a network signal; a fire retardant container for receiving fire retardant; an activation means for controlling a delivery pump connected to the fire retardant container; a retardant distribution means connected to the delivery pump for distributing fire retardant in an outdoor environment; a processor in communication with the network device and the activation means, the processor configured to: determine an activation signal based on the network signal; and transmit the activation signal to the activation means to activate the delivery pump and distribute fire retardant via the retardant distribution means.

In at least one example embodiment, the network device may be a wired network device.

In at least one example embodiment, the network device may be a wireless network device.

In at least one example embodiment, the fire suppression system may further include a remote sensor device, the remote sensor device including a network device for transmitting the network signal to the network device, the network signal comprising at least one selected from the group of an air temperature measurement, a ground temperature measurement, an ozone measurement, a relative humidity measurement, a soil moisture measurement, an air particulate measurement, and a carbon monoxide measurement.

In at least one example embodiment, the fire suppression system may further include at least two remote sensor devices wherein the network device of each of the at least two remote sensor devices may include a mesh networking device.

In at least one example embodiment, the network devices of each fire suppression system and the remote sensor device may include a mesh networking device.

In at least one example embodiment, the processor may be further configured to adjust the activation signal to change at least one selected from the group of: a spray angle, a spray field, and a flow rate of the retardant distribution means based on the activation signal.

In at least one example embodiment, the fire suppression system may further include a wind speed sensor; a wind direction sensor; and wherein the processor may be configured to adjust the activation signal to change at least one selected from the group of: a spray angle, a spray field, and a flow rate of the retardant distribution means based on a wind speed signal from the wind speed sensor or a wind direction signal from the wind direction sensor.

In at least one example embodiment, an imaging sensor; wherein the processor may be configured to adjust the activation signal to change at least one selected from the group of: a spray angle, a spray field, and a flow rate of the retardant distribution means based on a video signal from the imaging sensor and a machine learning model.

In another broad aspect, there is provided a method of fire suppression, the method including: receiving, at a network device, a network signal; determining, at a processor in communication with the network device, an activation signal based on the network signal; activating a delivery pump based on the activation signal, the delivery pump pressurizing a fire retardant and delivering the pressurized fire retardant to an outlet pipe; and delivering, using at least one spray head connected to the outlet pipe, the fire retardant at a corresponding at least one spray field in an outdoor environment.

In at least one example embodiment, the network device may be a wired network device.

In at least one example embodiment, the network device may be a wireless network device.

In at least one example embodiment, the network signal may be received from a remote sensor device.

In at least one example embodiment, the network signal may be received from a user device.

In at least one example embodiment, the method may further include delivering, at a first spray head connected to the outlet pipe, the fire retardant at a first spray field in an outdoor environment; and delivering, at a second spray head connected to the outlet pipe, the first retardant at a second spray field in the outdoor environment.

In at least one example embodiment, the first spray field may be relative to a radial direction of the outlet pipe and the second spray field may be relative to a length direction of the outlet pipe.

In at least one example embodiment, the first spray field may be 360 degrees relative to the radial direction of the outlet pipe and the second spray field may be 90 degrees relative to the length direction of the outlet pipe.

In at least one example embodiment, the first spray field may extend 180 degrees relative to the radial direction of the outlet pipe and the second spray field may extend 45 degrees relative to the length direction of the outlet pipe.

In at least one example embodiment, the first spray head and the second spray head may include a field adjustment means, and the method may further include: adjusting the first spray field and the second spray field.

In at least one example embodiment, the first spray head and the second spray head may include an angular adjustment means, and the method may further include: adjusting the first spray field of the first spray head by a first spray angle; and adjusting the second spray field of the second spray head by a second spray angle.

In at least one example embodiment, the first spray head and the second spray head may include a flow rate adjustment means, and the method may further include: adjusting a flow rate of the fire retardant into the first spray field; and the method may further include: adjusting a flow rate of the fire retardant into the second spray field.

In at least one example embodiment, the fire retardant may be one of a liquid, a foam mixture, or a gel.

In at least one example embodiment, the fire retardant may be PHOS-CHEK®.

In another broad aspect, there is provided a method of installing a fire suppression apparatus, the method including: positioning the fire suppression apparatus in an outdoor environment; securing a securing means of the fire suppression apparatus in the outdoor environment; filling a fire retardant container of the fire suppression apparatus with fire retardant; connecting a network device of the fire suppression apparatus to a network, the network device for receiving a network signal to activate a delivery pump of the fire suppression apparatus; and activating an agitation means of the first suppression apparatus, the agitation means for agitating the fire retardant within the fire retardant container.

In at least one example embodiment, the method may further include: installing a remote sensor device in the vicinity of the fire suppression apparatus; and configuring a network device of the remote sensor device to connect to the network device of the fire suppression apparatus.

In at least one example embodiment, the network device may be a wired network device.

In at least one example embodiment, the network device may be a wireless network device.

In at least one example embodiment, the fire retardant may be a mixture of water and fire retardant concentrate.

In at least one example embodiment, the fire retardant concentrate may be a mineral-based fire retardant.

Other features and advantages of the present application will become apparent from the following detailed description. It should be understood, however, that the detailed description and the specific examples, while indicating embodiments of the application, are given by way of illustration and the scope of the claims should not be limited by these embodiments, but should be given the broadest interpretation consistent with the description as a whole.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1A is an example block diagram of an example system for fire suppression.

FIG. 1B is system diagram of a system for fire suppression and forest fire detection and prediction.

FIG. 2A is a cross-sectional view of a fire suppression apparatus according to an example embodiment.

FIG. 2B is a cross-sectional view of a fire suppression apparatus according to an example embodiment.

FIG. 3A is a top view of a fire suppression apparatus according to an example embodiment.

FIG. 3B are front views of a fire suppression apparatus according to example embodiments.

FIG. 3C is a perspective view of a fire suppression apparatus according to an example embodiment.

FIG. 4 is a cross-sectional view of a portion a fire suppression apparatus according to an example embodiment.

FIG. 5A is a perspective view of various spray field angles.

FIG. 5B is a top view of various spray field angles.

FIG. 5C is a top view of various spray field angles.

FIG. 6 is a fire suppression apparatus according to an example embodiment.

FIG. 7A is a fire suppression system according to an example embodiment.

FIG. 7B is a fire suppression system according to an example embodiment.

FIG. 7C is a fire suppression system according to an example embodiment.

FIG. 7D is a fire suppression system according to an example embodiment.

FIG. 8 is fire suppression system network according to an example embodiment.

FIG. 9 is which shows an example implementation of a fire suppression system network.

FIG. 10A is an example illustration of a fire suppression apparatus in operation.

FIG. 10B is an example illustration of a fire suppression apparatus in operation under windy conditions.

FIG. 10C is an example illustration of a fire suppression apparatus in operation under windy conditions.

FIG. 10D is an example illustration of a fire suppression apparatus in operation under windy conditions.

FIG. 11 is a perspective view of a fire suppression apparatus in operation according to an example embodiment.

FIG. 12 is an activation system on a user device according to an example embodiment.

FIG. 13 is a method diagram for activating a fire suppression apparatus in accordance with one or more embodiments.

FIG. 14 is a method diagram for installing a fire suppression apparatus in accordance with one or more embodiments.

### DETAILED DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to apparatus, systems, or methods having all of the features of any one of the apparatus, system, or methods described herein. It is possible that there may be an apparatus, system, or method described herein that is not an embodiment of any claimed subject matter. Any subject matter that is described herein that is not claimed in this document may be the subject matter of another protective instrument, for example, a continuing patent application, and the applicants, inventors or owners do not intent to abandon, disclaim or dedicate to the public such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

It should also be noted that the terms “coupled” or “coupling” as used herein can have several different meanings depending in the context in which these terms are used. For example, the terms coupled or coupling can have a mechanical, fluidic or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore, coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Exemplary communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The example systems and methods described herein may be implemented as a combination of hardware or software. In some cases, the examples described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

Some elements that are used to implement at least part of the systems, methods, and devices described herein may be implemented via software that is written in a high-level procedural language such as object-oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having at least one processor, an operating system, and the associated hardware and software that is used to implement the functionality of at least one of the methods described herein. The software program code, when read by the device, configures the device to operate in a new, specific, and predefined manner (e.g., as a specific-purpose computer) in order to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

As stated in the background, the prevalence of forest fires has become increasingly concerning. The rise of forest fires has devastating effects on the environment, leading to the death of wildlife, disruption of ecosystems, and destruction of habitats. This destruction is due, in part, to the latency between detecting the presence or onset of a forest fire and the lengthy mobilization of a system or team capable of responding to and extinguishing the fire. This problem is especially rampant in remote wooded areas that are not stationed with personnel equipped to detect and suppress forest fires when they occur.

To this end, it has been appreciated that mobile and portable fire suppression apparatus may assist in mitigating the impact of forest fires and reduce property damage, improving safety and resilience in wildfire-prone areas.

In view of the foregoing, the present disclosure relates to apparatus, systems, and methods that enable fire suppression. In one example, the disclosed embodiments enable the prediction, detection, and suppression of fires. This includes, for example, the prevention of forest fires or the protection of structures or property from oncoming fires. It will be understood, however, that the disclosed embodiments may also be applied to the fire suppression of various other vulnerable areas.

As provided in greater detail, a fire suppression system is disclosed for the suppression of fires. To facilitate fire suppression, the fire suppression system may include one or more fire suppression apparatuses. The fire suppression system may also include other system components that facilitate fire suppression. For example, these may include fire retardant distribution system, an activation system, a communication system, etc. In some cases, the fire suppression system may further include features that facilitate the manual or automatic activation of the fire suppression apparatus, as needed. (e.g., through a user device).

In at least some example cases, the fire suppression apparatus may be configured with features to be adaptable in various situations. For example, the fire suppression apparatus may have multiple spray heads strategically located on various locations of the fire suppression apparatus depending on where fire suppressant coverage is required.

In an example application, the fire suppression apparatus may feature a drone to provide more flexible and reactive coverage. In this embodiment, the drone is tethered to the fire suppression apparatus which supplies the drone with electricity and fire retardant.

The disclosed fire suppression apparatus may be integrated with existing fire detection and monitoring systems (e.g., smoke detectors or other sensors). In this way, the fire suppression apparatus can be activated externally based on real-time fire alerts. This not only enhances the efficiency of the fire suppression system but also allows the fire suppression apparatus to be seamlessly adopted or retrofitted with existing fire protection solutions.

The disclosed fire suppression apparatus may also be portable. For instance, the fire suppression apparatus may not be equipped with securing means (i.e., placed on the ground without being firmly secured). Although this may reduce the stability of the fire suppression apparatus and hinder the ability to mount the fire suppression apparatus on unstable or uneven ground, the fire suppression apparatus gains the advantage of portability.

The fire suppression apparatus and system may also be modular and scalable. As described above, the fire suppression apparatus can be pre-configured in way that is tailored to respond to its environment, as needed. In addition, the fire suppression system may be scaled by adding multiple fire suppression apparatus linked by a common communication system. In this way, the fire suppression system may be implemented on a larger scale with multiple fire suppression apparatus operating in concert.

In view of the foregoing, the disclosed embodiments provide for portable, ready to deploy apparatus for fire suppression. The fire suppression apparatus may be deployed as a standalone unit in remote areas. In other words, the fire suppression apparatus may be a self-contained system, with no reliance on external infrastructure or nearby water sources.

Thus, the disclosed methods and systems offer a comprehensive solution to address the challenges posed by forest fires. Its rapid response, efficient fire suppression capabilities, customizable coverage, and standalone operation make it an invaluable tool for protecting structures and communities from the devastating impacts of wildfires.

It is further believed that the disclosed embodiments, which enable remote fire suppression, also assists in preventing forest fires before they reach uncontrollable levels, as they capable of responding more quickly than conventional methods. This, in turn, facilitates the preservation of life by removing the need for personnel to be on site to suppress forest fires.

### I. GENERAL SYSTEM OVERVIEW

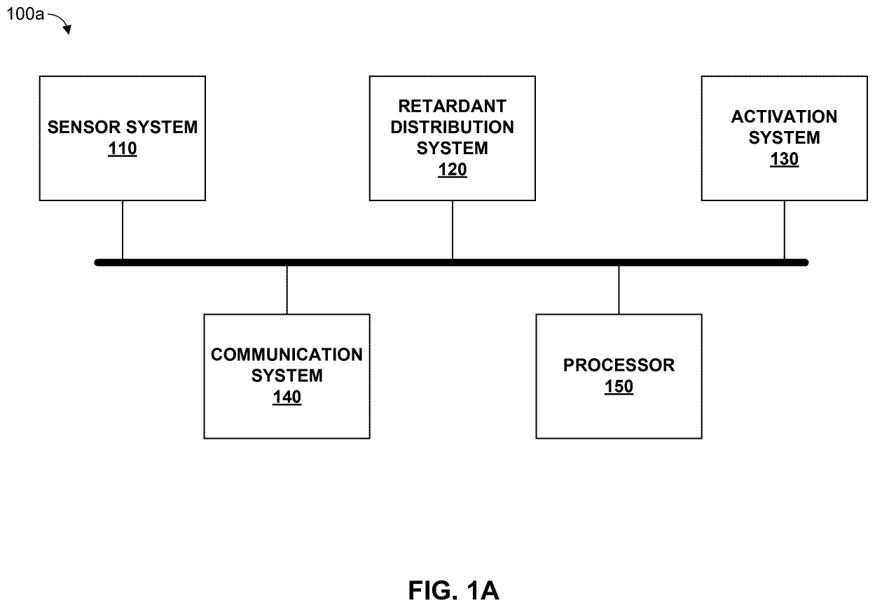

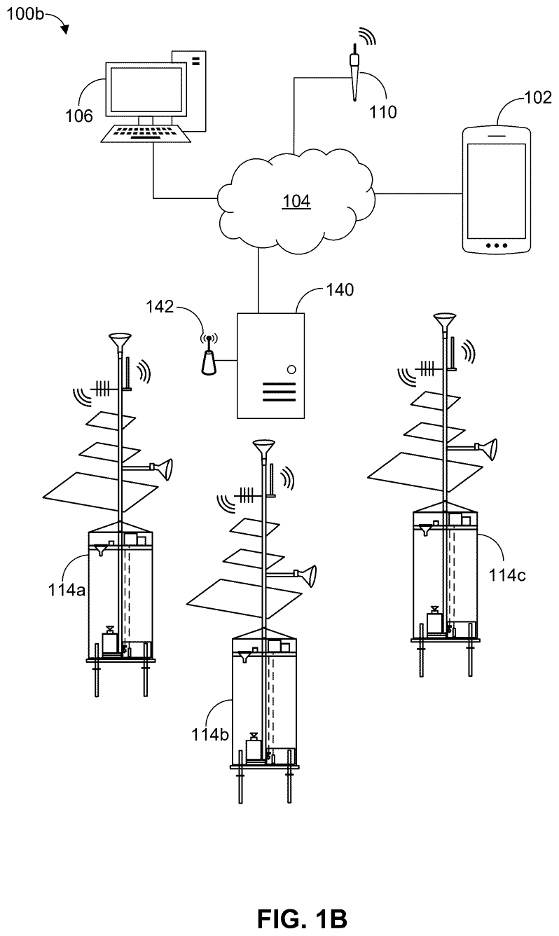

Reference is now made to FIG. 1A, which shows a block diagram of an example system 100a for fire suppression.

As shown, system 100a includes a sensor system 110, a retardant distribution system 120, an activation system 130, a communication system 140, and a processor 150.

In operation, the sensor system 110 may interact with the processor 150 via the communication system 140, to engage the activation system 150, triggering the retardant distribution system 120 of the fire suppression system 100a.

The sensor system 110 includes an interconnected network of sensors designed to gather diverse types of data from its surrounding environment. These sensors are configured to detect and measure physical, chemical, or environmental parameters in real-time. For example, sensors may include weather sensors for detecting and measuring temperature, humidity, atmospheric pressure, or precipitation; air quality sensors for detecting and measuring air pollutants, particulate matter, or different gasses (e.g., ozone and carbon monoxide); soil sensors for detecting and measuring soil moisture, pH levels, or soil temperature; imaging sensors for detecting persons, wildlife, the presence of smoke, or the presence of fire; and motion or vibration sensors for measuring and detecting seismic activity.

The sensors of sensor system 110 may be physically proximate to the system 100a or may be located remotely and may provide sensor data using a network communication protocol of the communication system 140.

The sensors in the sensor system 110 collect data from the external environment and communicate the data via the communication system 140 to a processor 150.

The processor 150 analyzes the data collected from the sensors to determine whether operation of the fire suppression system 100a is required. In some examples, the processor 150 processes the incoming sensor data in real time. The processor 150 may aggregate the incoming sensor data, organize it, and preprocess it to a format that is suitable for analysis. Preprocessing may include removing outliers from or omitting missing values in the sensor data. The processor 150 may implement various algorithms, statistical methods and processes to analyze the sensor data. For example, the processor 150 may use analyze the sensor data and compare the data with historical patterns to forecast future conditions or identify potential anomalies may indicate the onset of a fire. The processor 150 may relay this information via the communication system 140 to the activation system 130 to determine whether to operate the fire suppression system 100a.

The activation system 130 receives signals from the processor 150 to determine whether operation of the fire suppression system 100a is required. Otherwise, the activation system 130 remains on standby. Even when on standby, in some examples, the activation system 130 continuously monitors incoming data from the processor 150.

For example, the processor 150 may send a signal to the activation system 130 via the communication system 140. The received signal may exceed a predetermined threshold of the activation system 130 and consequently initiate the operation of the fire suppression system 100a.

In some examples, the activation system 130 may receive a signal from the processor 150 based on the analysis of the incoming sensor data. The signal may automatically trigger the activation system 130 to initiate the operation of the fire suppression system 110a. Alternatively, or in addition, a user may directly interact with the activation system 130 to activate the fire suppression system 100a. In this case, the user may operate a user device to manually transmit an activation signal to the activation system 130 directly, regardless of whether a predetermined threshold has been exceeded. Alternatively, or in addition, the activation system 130 may use a combination of automatic and manual activation. That is, although the received signal may exceed a predetermined threshold of the activation system 130, the activation system 130 may not initiate the operation of the fire suppression system 100a without receiving confirmation from a user operating a user device. In still another example, the activation system 130 may be a mechanical or electrical switch, located on or nearby the fire suppression system 100a.

The activation system 130 controls the operation of the retardant distribution system 120. Upon receiving a signal from the activation system 130 via the communication system 140, the retardant distribution system 120 may actuate electrical and mechanical components of the fire suppression system 100a. For example, as described in greater detail below, in a preferred embodiment, the retardant distribution system 120 may be integrated with a fire suppression apparatus (not shown). The fire suppression apparatus may include a means of distributing fire retardant to an outdoor environment.

The communication system 140 provides an infrastructure designed to facilitate the transmission of information between the various components of the fire suppression system 100a. For example, as described above, the communication system 140 transmits collected sensor data from the sensor system 110 to the processor 150 or the communication system 140 transmits the activation signal from the processor 150 to the activation system 130.

The communication system 140 may also be connected to external networks. In some examples, the communication system 140 may notify local authorities such as a fire brigade or a fire warden when a fire is detected.

Referring to FIG. 1B, which shows a system drawing of an example system for fire suppression.

As shown, the fire suppression system 100b includes a user device 102, a network 104, a remote server 106, a sensor system 110, and a communication system 140 for propagating a network signal from a network device 142 to at least one fire suppression apparatus 114.

In some embodiments, the network device 142 is a wired network device. The network device 142 can include a radio that communicates utilizing CDMA, GSM, GPRS or Bluetooth protocol according to standards such as IEEE 30 802.11a, 802.11b, 802.11g, or 802.11n. The network device can be used by the user device 102 to communicate with other devices or computers.

In some embodiments, the network device 142 is a wireless network device. The network device 142 may provide communications over the local wireless network using a protocol such as Bluetooth (BT) or Bluetooth Low Energy (BLE). The network device may communicate with the wireless transceiver sensor systems 110 of the one or more fire suppression apparatuses 114 to transmit and receive information via local wireless network.

The network 104 may be any network or network components capable of carrying data including Internet, Ethernet, fiber optics, satellite, mobile, wireless (e.g., Wi-Fi, WiMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced, Worldwide Interoperability for Microwave Access (WiMAX), etc.) and others, including any combination of these.

User devices 102 may be used by an end-user to access an application (not shown) running on a remote server 106. For example, the application may be a web application, or a client/server application. The user devices 102 may be a desktop computer, mobile device or laptop computer. The user devices 102 may be in network communication with remote server 106 via network 104. The user devices 102 may display the application and may allow a user to manually activate or confirm the activation of one or more fire suppression apparatuses 114. The end user may be a property owner, property manager, a fire brigade, a fire marshal officer, or a corporate organization such as a company dedicated to fire suppression, or another interested party.

Remote servers 106 may provide a web application that is accessible by the user devices 102. The web application may provide user authentication functionality as known, so that a user may create an account and/or log into the web application in order to request or receive fire suppression apparatus information including the activation history of a fire suppression apparatus. Alternatively, the remote server 106 may connect to one or more user applications running on user device 102 using an API (Application Programming Interface). For example, an application downloaded from the Google® Play Store® or the Apple® App Store may be used on user device 102 and may connect to the remove server 106 using an API. The remote server 106 may provide the fire suppression apparatus prediction functionality to a user as described herein.

Remote servers 106 may implement an Application Programming Interface (API) to receive requests from the user devices 102, or from a third party (not shown). The remote server 106 may reply to the API requests with API responses, and the API responses may provide the functionality of the web application provided by remote servers 106. The API may receive requests and send responses in a variety of formats, such as JavaScript Object Notation (JSON) or extensible Markup Language (XML).

Remote server 106 may implement one or more external APIs, as described above. The remote server 106 may be a physical server, may be the same server device as the device running a database (not shown), or may be provided by a cloud provider such as Amazon® Web Services (AWS).

Remote server 106 may have a web server provided thereon for providing web-based access to the software application providing the API and/or the software application providing the web application. The web server may be one such as Apache®, Microsoft® IIS®, etc. The software application providing the API and the web application may be Apache® Tomcat, Ruby on Rails, or another web application framework as known.

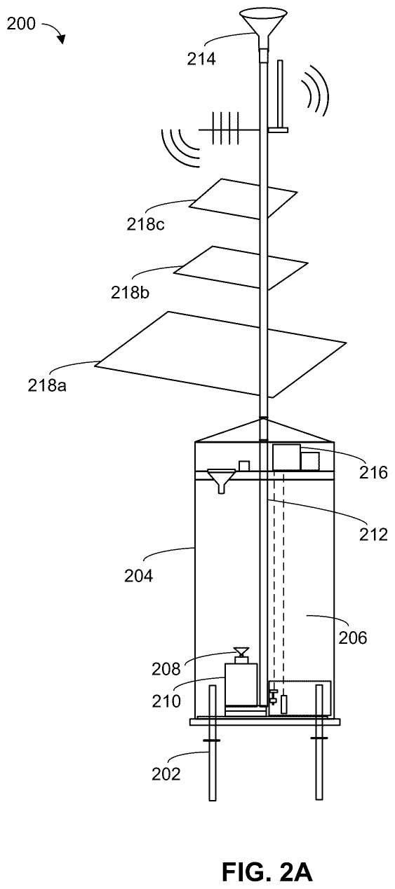

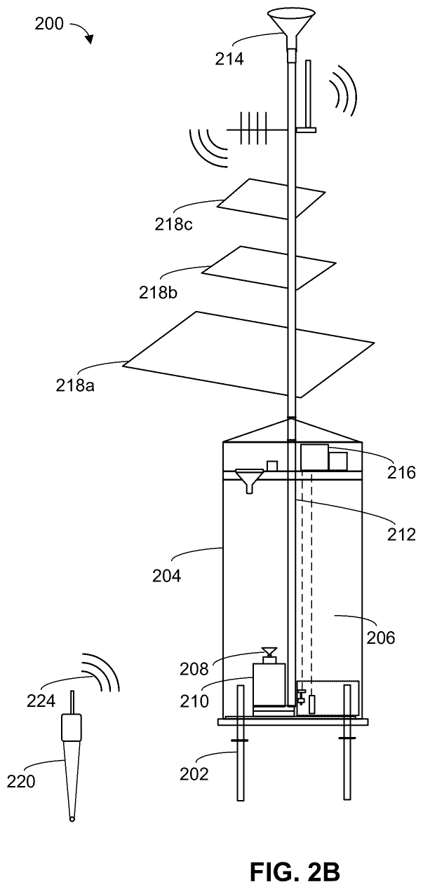

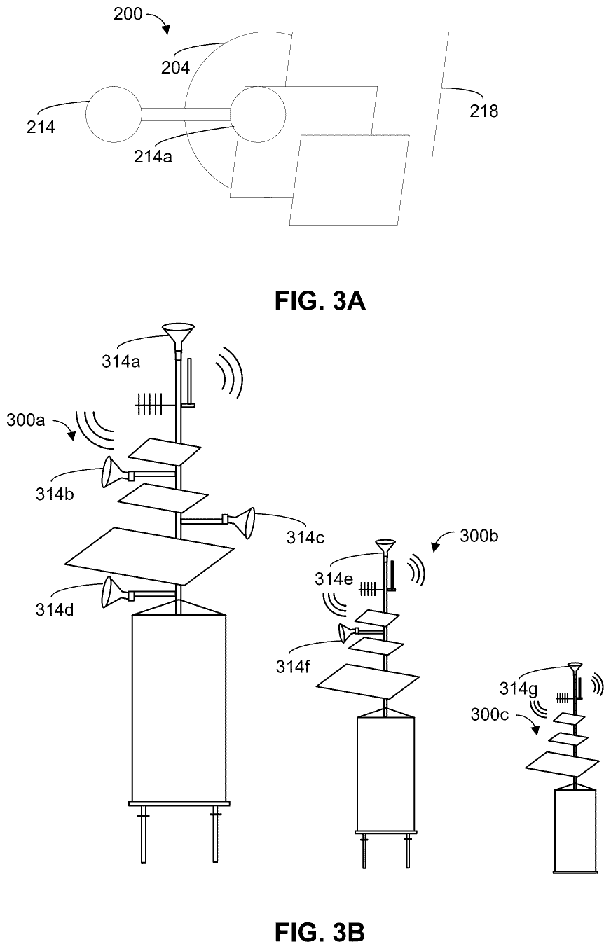

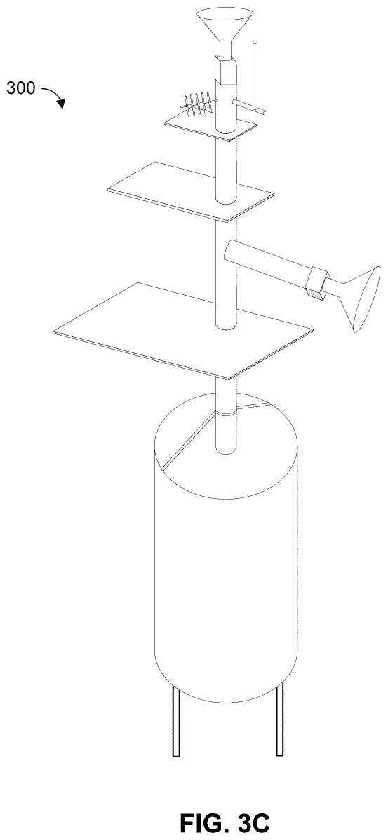

Referring to FIGS. 2A, 3A, and 3C together, which shows a cross-sectional view of a fire suppression apparatus, a top view of the fire suppression apparatus, and a perspective view of the fire suppression apparatus, respectively, according to an example embodiment.

As shown, the fire suppression apparatus 200, includes a securing means 202 for securing the fire suppression apparatus 200 in an outdoor environment. For example, the fire suppression apparatus 200 may be located within a homeowner's property to protect structures and vegetation from oncoming fires. In other examples, the fire suppression apparatus 200 may be located in a high-risk wooded area to proactively prevent forest fires.

The securing means 202 enables the fire suppression apparatus 200 to be secured to a variety of terrains. For example, the fire suppression apparatus 200 may be placed in a forested area and secured such that animals or environmental factors like wind to not topple it. The fire suppression apparatus 200 may also be mounted on uneven terrain, for example, on the side of a mountain. The securing means 202 of the fire suppression apparatus 200 ensures that the operation of the fire suppression apparatus 200 remains reliable even as a fire approaches.

The fire suppression apparatus 200 includes a retardant container 204 connected to the securing means for storing fire retardant 206. The retardant container 204 may be made of durable heat-resistant material that can store various types of chemicals safely. For example, the retardant container may be made of steel, fiberglass, high-density or low-density polyethylene, aluminum, or composite materials like carbon fiber. The retardant container 204 may vary in size and liquid capacity, depending on the application. In a preferred embodiment, the retardant container is a durable steel barrel with a capacity of 50 liquid gallons.

The fire suppression apparatus 200 may have different sizes depending on the application. In some examples, larger fire suppression apparatuses 200 may have a larger retardant container 204. The larger retardant container 204 may be activated multiple times before the retardant container 204 needs to be refilled. In this way, a larger retardant tank 204 may be placed in a remote area for long period of time without the need for maintenance. In other examples, smaller fire suppression apparatuses 200 may have a smaller retardant tank 204. The reduced size may also be helpful for placing within outdoor structures (e.g., within a gazebo, or under a deck). In still other examples, even smaller fire suppression apparatus 200 may not require a securing means, thus, offering a lightweight, portable structure that can be readily transported to different locations, as needed.

The fire suppression apparatus 200 may also include an agitation pump means 208 for providing agitation of the fire retardant 206 within the retardant container 204. The fire retardant may consist of environmentally friendly substances such as clay, fertilizer, and foam, combined with a standard forest fire blend. Similar to other retardant containers such as those used for fire extinguishers, in some embodiments, the fire retardant 206 in the retardant container 204 is pre-mixed mixture of water and a mineral-based fire retardant concentrate such as PHOS-CHEKR. Filling the fire retardant containers with pre-mixed fire retardant may be advantageous as conventional fire suppressant devices, like fire extinguishers and sprinkler systems, can be readily deployed in response to a fire. A drawback of this feature, however, is that eventually the fire retardant will settle in the container, leading to sedimentation and expiry. The inclusion of an agitation pump means 208 in the retardant container 204 may prevent the pre-mixed fire retardant 206 from settling, thereby preventing sedimentation, extending the shelf-life of the pre-mixed fire retardant 206 significantly.

The agitation pump means 208 may, for example, use any of stirring, shaking, ultrasonic agitation, magnetic agitation, shearing, recirculation, pumping, or rotating impellers. In a preferred embodiment, the agitation pump means 208 is a submersible 12V pump which circulates the fire retardant 206 within the retardant container 204 to keep the fire retardant 206 well-mixed to prevent sedimentation.

The fire suppression apparatus 200 may also include a delivery pump 210 with an inlet (not shown) in fluid communication with the fire retardant 206 in the retardant container 204. When the fire suppression apparatus 200 is activated, the delivery pump 210 pulls fire retardant 206 from the retardant container 204 and delivers pressurized fire retardant 206 at an outlet (not shown) of the delivery pump 210.

The delivery pump 210 may have different power requirements, depending on the application. Further, the delivery pump 210 may be capable of delivering pressurized fire retardant 206 at different flow rates. In a preferred embodiment, the delivery pump 210 is a 24V DC ¾″ pump with a flow rate of 11 gallons per minute.

The fire suppression apparatus 200 may also include an outlet pipe 212 connected to the outlet of the delivery pump 210. The outlet pipe 212 is capable of receiving the pressurized fire retardant 206 and transporting it downstream from the delivery pump 210 when the fire suppression apparatus 200 is activated. Thus, the outlet pipe 212 may be made of materials capable of delivering high-pressure fire retardant 206 while preventing leakage or corrosion.

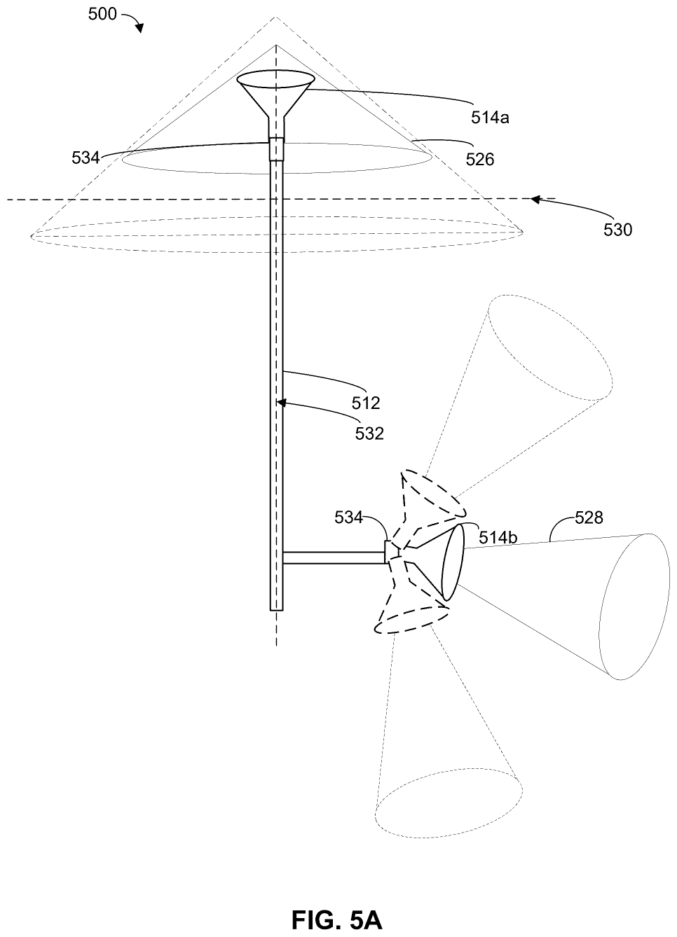

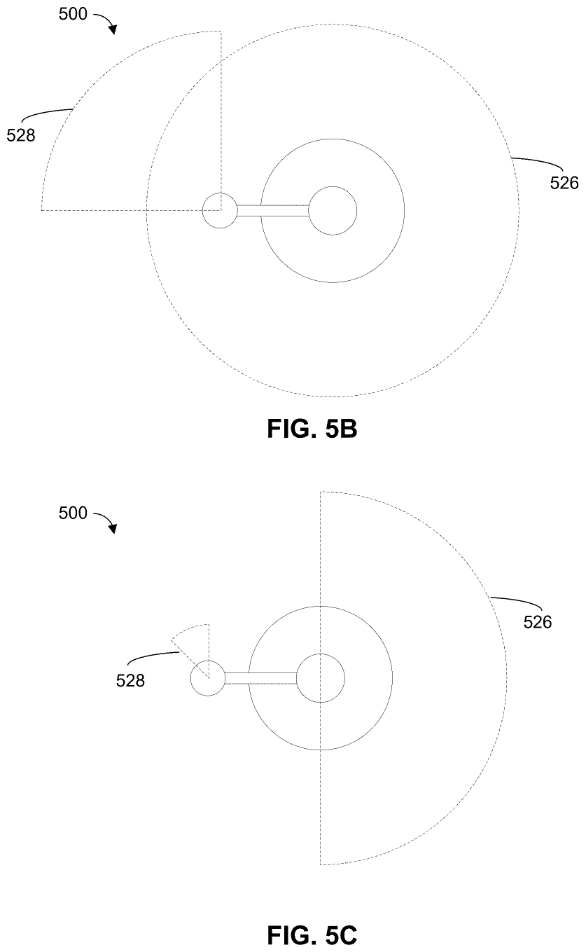

The fire suppression apparatus 200 includes at least one spray head 214 for receiving the pressurized fire retardant 206 from the outlet pipe 212. The spray heads 214 may be capable of handling a flow rate of 6-60 gallons per minute from the outlet pipe. The spray head 214 may be, for example, a Sime Funny Sprinkler or a VYR 35. Each spray head 214 may have a corresponding spray field (described in greater detail below with reference to FIGS. 5A,5B, and 5C).

In some embodiments, the fire suppression apparatus 200 may include an electrical storage means 216 for powering the agitation pump means 208 and the delivery pump 210. The electrical storage means 216 provides power to the components of the fire suppression apparatus 200 such as the agitation pump 208 and the delivery pump 210. In some embodiments, there may be more than one electrical storage means 216 connected to more than one component of the fire suppression apparatus 200. In this way, the fire suppression apparatus 200 may remain operational even if more than one electrical storage means 216 malfunctions. In a preferred embodiment, the electrical storage means 216 is a 24V Lithium-Ion Phosphate battery.

In some embodiments, the fire suppression apparatus 200 may include a solar panel 218 for charging the electrical storage means 216. In some embodiments, the solar panels 218 directly charge the components of the fire suppression apparatus 200 such as the agitation pump 208 and the delivery pump 210. In this way, the fire suppression apparatus 200 may remain operational even if the electrical storage means 216 malfunctions. The solar panels 218 provide an extra layer of redundancy to ensure that the operation of the fire suppression apparatus 200 is reliable.

In some embodiments, the electrical storage means 216 may transfer excess energy to an external battery (not shown).

Referring to FIG. 2B, which shows a cross-sectional view of a fire suppression apparatus according to an example embodiment.

In some embodiments, the fire suppression apparatus 200 includes a remote device 220 for activating the delivery pump 210. The remote device 220 transmits and receives signals to and from the communication system 222 on the fire suppression apparatus 200.

In some embodiments, the remote device 220 may be a remote sensor. In some embodiments, the remote sensor includes a network device for transmitting the network signal 224 to the network device. The transmitted network signal 224 includes at least one of an air temperature measurement, a ground temperature measurement, an ozone measurement, a relative humidity measurement, a soil measurement, an air particulate measurement, and a carbon monoxide measurement.

The remote sensor may measure the temperature of the air to predict the onset of or detect the presence of a fire. For example, an increase in temperature may indicate the presence of a fire. In some cases, when the increase in air temperature is rapid, this may indicate that the fire is dangerously close which may trigger the immediate activation of the delivery pump 210. In other cases, where the increase in air temperature is gradual, the network signal 224 may not surpass the predetermined threshold required to activate the delivery pump 210.

Alternatively, or in addition, the remote sensor may measure a ground temperature to predict the onset of or detect the presence of a fire. For example, a high ground temperature can dry out vegetation and soil thereby creating favorable conditions for the ignition and spread of fire.

Alternatively, or in addition, the remote sensor may measure the presence of ozone to predict the onset of or detect the presence of a fire. For example, high levels of ozone may precede the occurrence of a lightning strike, which are a leading cause of forest fires in dry wooded areas.

Alternatively, or in addition, the remote sensor may measure the relative humidity to predict the onset of or detect the presence of a fire. For example, low humidity means can desiccate vegetation, making them more susceptible to catching fire. When humidity levels drop the moisture content in vegetation decreases, making it easier for fires to ignite and spread. This dryness also affects the flammability of other materials, like wood or paper.

Alternatively, or in addition, the remote sensor may measure the soil moisture to predict the onset of or detect the presence of a fire. For example, low soil moisture may influence the combustibility of organic matter like fallen leaves or branches. Low soil moisture may make ground debris more susceptible to ignition and indicate the potential for faster fire spread and increased intensity.

Alternatively, or in addition, the remote sensor may measure the particulates in the air to predict the onset of or detect the presence of a fire. For example, a fire may produce smoke and other particulate matter in the air. Sudden spikes in particulate matter can indicate an approaching fire.

Alternatively, or in addition, the remote sensor may measure the presence of carbon monoxide to predict the onset of or detect the presence of a fire. For example, carbon monoxide may be emitted in the initial stages of a fire, even before visible signs of smoke or flame are apparent.

Alternatively, or in addition, the remote sensor may use an imaging sensor to detect the presence of persons, the presence of smoke, or the presence of fire. For example, if a person is detected within the range of the fire suppression apparatus 200, the fire suppression apparatus 200 may cease operation. In some examples, the imaging sensor is a camera, an ultrasound sensor, thermal sensor, a hyperspectral imager, or any combination of these.

Each of these measurements may be used in combination with any of the other measurements for determining whether the fires suppression apparatus 200 should be activated. For example, each measurement may be used in a weighted average algorithm to determine whether a predetermined threshold is exceeded, thereby triggering the activation of the fire suppression apparatus 200. In other cases, each measurement may be used independently from any other measurement to determine whether the fire suppression apparatus 200 should be activated. For example, the fire suppression apparatus 200 may only activate if all the sensor measurements, described above, exceed predetermined thresholds for each of their respective sensors. This type of algorithm may be used to avoid false positives. For example, the fire suppression apparatus 200 may only be activated if more than half of the measurements exceed a threshold (e.g., a temperature threshold is exceeded, a humidity threshold is exceeded, and a carbon monoxide threshold is exceeded).

In contrast, to ensure reliability, each measurement may be used in independently from one another as a redundancy, to ensure that the fire suppression apparatus 200 is activated even if one or more of the sensors is malfunctioning. For example, the fire suppression apparatus 200 may activate if a single sensor measurement, described above, exceeds a predetermined threshold for its respective sensor (e.g., a temperature threshold is exceeded, a humidity threshold is not exceeded, and a carbon monoxide threshold is not exceeded).

Referring now to FIG. 3B, which shows front views of fire suppression apparatuses with different spray nozzle configurations according to example embodiments.

The fire suppression apparatus 300 may have different spray nozzle configurations depending on the application. It will be understood that the fire suppression apparatus 300 may include any number of spray heads 314. It will be further understood that the spray heads 314 may be connected to any location along the outlet pipe that is external to the retardant container to provide a strategic advantage as to maximize the coverage of the fire suppressant apparatus 300.

As shown in the illustrated example, a fire suppression apparatus 300a may have four spray nozzles located along the outlet pipe. Although the spray head 314a disposed at the top of the fire suppression apparatus 314b may generally be configured to provide wide range coverage, the other spray heads 314a, 314b, 314c may provide more targeted coverage for areas that the spray head 314a may not be able to consistently reach (e.g., below the eaves of the roof of a building). Further, spray heads 314a, 314b, 314c may act as a redundancy to ensure that high-value areas are covered with fire retardant even if, for example, spray head 314a malfunctions.

In other examples, as shown in the illustrated example, a fire suppression apparatus 300b may only have two spray nozzles 314e, 314f located along the outlet pipe. The fire suppression apparatus 300b may only require targeted coverage by spray head 314f in a single location. In addition, a fire suppression apparatus 300 with fewer spray heads 314 attached to the outlet pipe may provide more sustainable and reliable fire retardant delivery. That is, a fire suppression apparatus 300 with fewer spray heads 314, may require a low power delivery pump to service the spray heads 314 as less pressure may be required to ensure consistent delivery of fire retardant. Further, a fire suppression apparatus 300 with fewer spray heads 314 will not require as much fire retardant, thereby enabling more activations before the retardant container needs to be refilled.

In still other examples, a shown in the illustrated example, a fire suppression apparatus 300c may only have one spray nozzle 314g located along the outlet pipe. In such cases, the fire suppression apparatus 300c may be used as a more portable unit or may be located in areas that only require wide spread coverage.

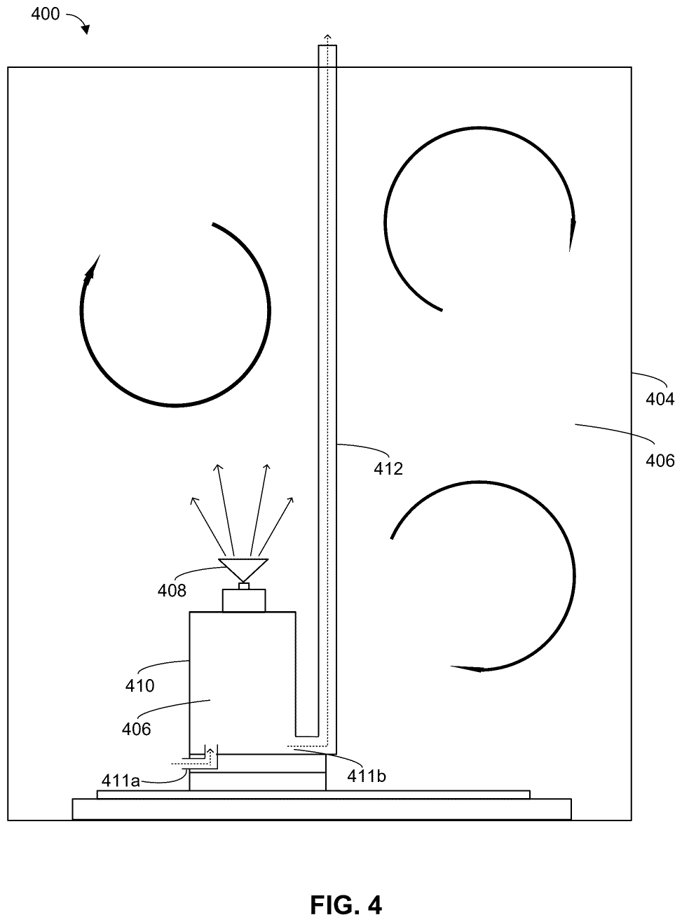

Referring now to FIG. 4, which shows a cross-sectional view of a portion of the fire suppression apparatus.

In some embodiments, the fire suppression apparatus 400 may include a delivery pump 410 is submerged within the fire retardant 406. An inlet 411a of the delivery pump 410 is also in fluid communication with the fire retardant 406 in the retardant container 404. When the delivery pump 410 is activated, the delivery pump 410 delivers pressurized fire retardant 406 at an outlet 411b of the delivery pump 410 connected to an outlet pipe 412.

In some examples, the delivery pump 410 services more than one outlet pipe 412. That is, the delivery pump 410 may be located within a central retardant tank 404 connected to many outlet pipes, each outlet pipe 412 having spray heads attached to it in strategic locations to maximize coverage. In this case, the delivery pump 410 may select which outlet pipe 412 to deliver fire retardant 406 to as required.

As described above, the agitation pump means 408 circulates fire retardant 406 within the retardant container 404 to prevent the fire retardant 406 settling. In the illustrated example, the agitation pump means 408 is a submersible pump sprayer that circulates fire retardant 406 in the retardant container 404.

In some embodiments, the fire suppression apparatus 400 may include an ultrasonic volume sensor (not shown) to monitor the volume of the fire retardant 406 within the retardant container 404. When the fire retardant levels are low, the fire suppression apparatus 400 may notify a user, for example, via a user device that the retardant tank 404 needs to be refilled.

Referring now to FIGS. 5A, 5B, 5C together, there is shown various spray fields of a fire suppression apparatus according to an example embodiment.

In some embodiments, the fire suppression apparatus 500 includes a first spray head 514a connected to the outlet pipe 512 along a length direction 532 and having a first spray field 526. The first spray head 514a receives pressurized fire retardant from the outlet pipe 512 and delivers fire retardant in the first spray field 526 in the outdoor environment. As shown, the first spray field 526 is relative to a radial direction 530 of the outlet pipe 512.

The fire suppression apparatus 500 also includes a second spray head 514b connected to the outlet pipe 512 along the radial direction 530 and having a second spray field 528 different from the first spray field 526. The second spray head 514b receives pressurized fire retardant from the outlet pipe 512 and delivers the fire retardant in the second spray field 528 in the outdoor environment. As shown, the second spray field 528 is relative to a length direction 532 of the outlet pipe 512.

In some embodiments, the fire suppression apparatus 500 includes a user adjustment means 534 for adjusting the various parameters of each of the first and second spray heads 514, respectively. For example, in some embodiments, the user adjustment means 534 includes a field adjustment means for adjusting each of the first spray field 526 and the second spray field 528, respectively (described in greater detail below with respect to FIGS. 5B and 5C).

In some embodiments, the user adjustment means 534 includes an angular adjustment means for adjusting each respective spray field by a spray angle. As shown in the illustrated example, the second spray head 514b may be adjusted to different angles using the user adjustment means 534. Although the angle of the first spray head 514a is not shown to be adjusted, it is understood that the angle of the first spray head 514a may be adjusted using the user adjustment means 534.

In some embodiments, the user adjustment means 534 includes a flow rate adjustment means for adjusting the flow rate of the fire retardant in the first spray field 526 and the second spray field 528, respectively. As shown in the illustrated example, the flow rate of the fire retardant delivered to the first spray head 514a may be adjusted to deliver more fire retardant using the user adjustment means 534. Although the flow rate of the second spray head 514b is not shown to be adjusted, it is understood that the flow rate of the second spray head 514b may be adjusted using the user adjustment means 534.

As shown in FIGS. 5B and 5C, in some embodiments, the first spray field 526 extends 360 degrees relative to the radial direction (not shown) of the outlet pipe and the second spray field 528 extends 90 degrees relative to the length direction (not shown) of the outlet pipe. In some embodiments, the first spray field 526 extends 180 degrees relative to the radial direction of the outlet pipe and the second spray 528 field extends 45 degrees relative to the length direction of the outlet pipe. In some examples, the spray field angle is adjusted using the user adjustment means, as described above.

Although only discrete spray angles are shown for the spray fields, it will be understood that the spray field angles may be adjusted to service all reasonable angles. For example, the spray field angles for both the first and second spray field 526, 528 may be adjusted to cover anywhere between 0 to 360 degrees.

Referring to FIG. 5A, Generally, in a non-limiting example, the first spray head 514a is located along the length direction 512 of the fire suppression apparatus 500, and the first spray field 526 is delivered to the outdoor environment to cover a wide area. For example, the first spray field 526 may cover the roof of a house or the surrounding foliage. The second spray head 514b is located along the radial direction 530 of the fire suppression apparatus 500, and the second spray field 528 is delivered to the outdoor environment to cover a targeted area. For example, the second spray field 528 may cover the siding of the house, below the eaves, or may be targeted to specific areas of interest (e.g., outdoor furniture, entrances and exits, or vehicles).

Although the illustrated example shows the first spray head 514a and second spray head 514 having different spray fields to perform different functions (i.e., wide coverage versus targeted coverage), it will be understood that any spray head attached to the fire suppression apparatus 500 may be configured to have any angle of spray field described.

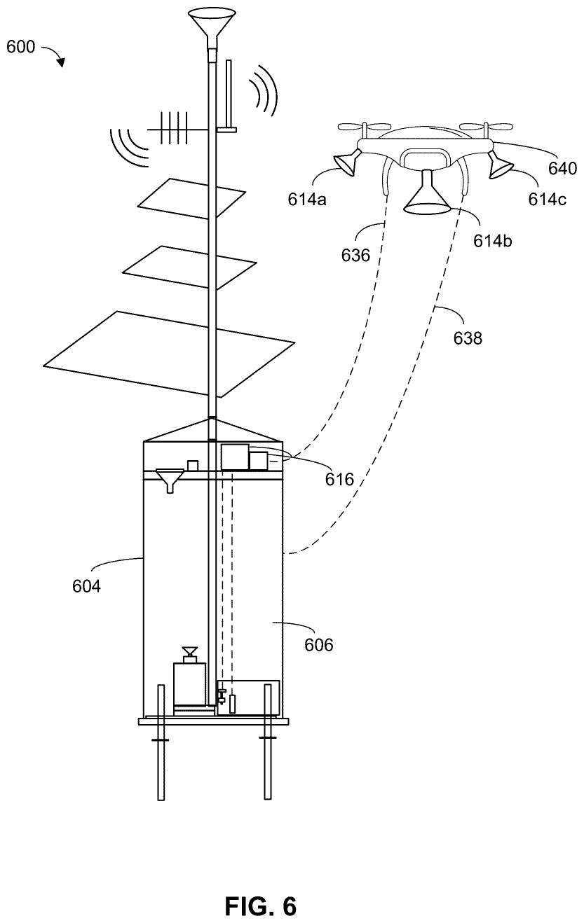

Referring now to FIG. 6 which shows a fire suppression apparatus 600 according to an example embodiment.

The fire suppression apparatus 600 includes a drone docked on top of the retardant tank. The drone 640 may be tethered to the fire suppression apparatus 600 via a power line 636, connected to an electrical storage means 616, and a feed line 638, connected to the retardant tank 604 which feeds the drone 640 with fire retardant. Alternatively, the drone 640 may have a rechargeable battery and may dock with the fire suppression apparatus 600 in order to recharge. Alternatively, the drone may have its own refillable retardant tank that may be filled from the main tank 604. In operation, the drone 640 flies within a radius of the fire suppression apparatus 600 spraying fire retardant 606 from the various nozzles 614a, 614b, 614c with which it is equipped. The drone 640 may include a high-pressure pump 614b for spraying high-pressure mist in the outdoor environment. In this embodiment, the capacity of the electrical storage 616 means may be increased to accommodate for the operation of the drone 640. The normal operation of the fire suppression apparatus 600 may occur simultaneously with the operation of the drone 640.

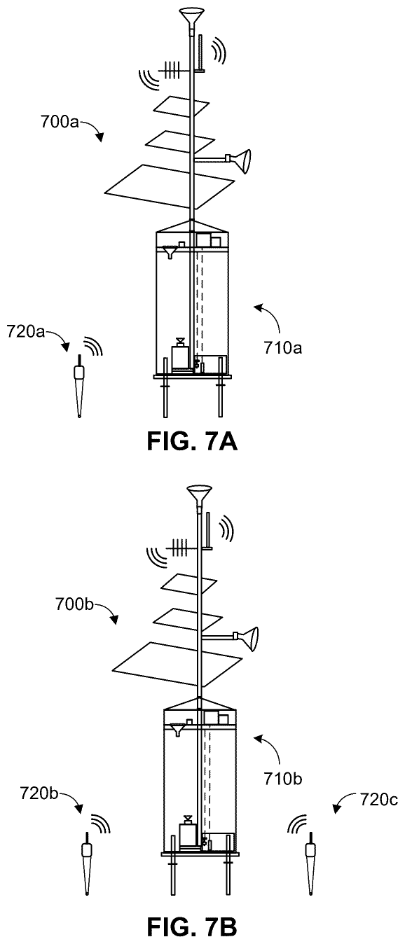

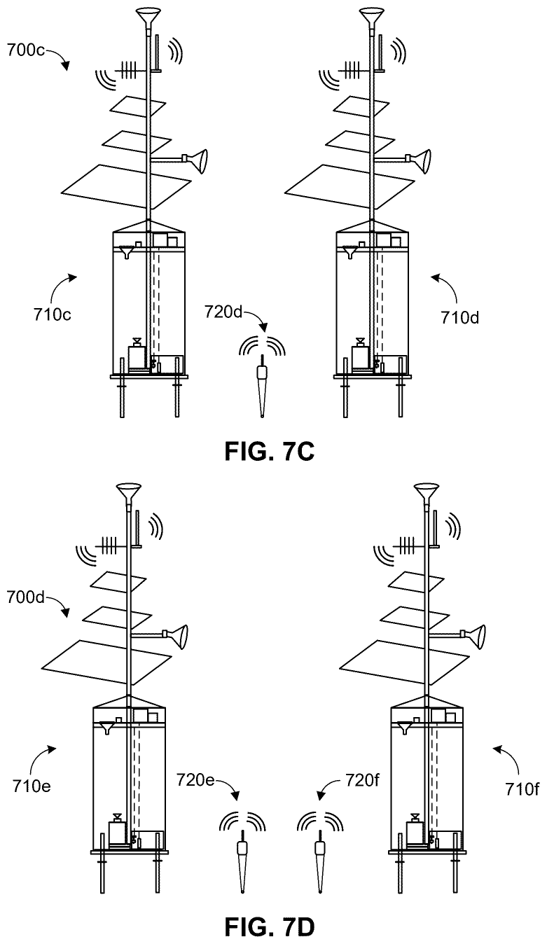

Referring now to FIG. 7A-7D together, which shows fire suppression systems according to example embodiments.

In the illustrated examples below, various combinations of fire suppression apparatus 710 and remote sensor devices 720 are integrated to form a fire suppression system 700.

For example, as shown in FIG. 7A, a fire suppression system 700a is shown including one fire suppression apparatus 710a and one remote sensor device 720a. In this example, the remote sensor device 720a communicates measured conditions of the outdoor environment to the fire suppression apparatus 710a. In some cases, the fire suppression apparatus 710a may activate based on the measured conditions received from the remote sensor device 720a. For example, fire suppression apparatus 710a may determine that the measured conditions received from the remote sensor device 720a may exceed a predetermined threshold, thereby triggering the activation of the fire suppression apparatus 710a.

In another example, as shown in FIG. 7B, a fire suppression system 700b is shown including one fire suppression apparatus 710b and two remote sensor devices 720b, 720c. In this example, the remote sensor devices 720b, 720c communicate measured conditions of the outdoor environment to the fire suppression apparatus 710b.

In some cases, the fire suppression apparatus 710b may activate based on one or both of the measured conditions received from the remote sensor devices 720b, 720c. For example, the fire suppression apparatus 710b may only activate if it is determined that the measured conditions received from both remote sensor devices 720b, 720c exceed a predetermined threshold. In such an implementation, the specificity of the fire suppression system 700b is prioritized. That is, this implementation may prevent false positive activations, as the two remote sensor devices 720b, 720c need to measure conditions that exceed the predetermined threshold before the fire suppression system 700 is activated.

In other cases, the fire suppression apparatus 710b may activate even if it is determined that the measured conditions of only one of remote sensor device 720b or remote sensor device 720c exceed a predetermined threshold. In such an implementation, sensitivity of the fire suppression system 700b is prioritized. That is, this implementation may classify negative results as positive, as one remote sensor device 720b may transmit measured conditions that exceed a predetermined threshold while the other remote sensor device 720c may transmit measured conditions that do not exceed a predetermined threshold. This may be important in situations where the protection of property is critical or when one of the remote sensor devices 720b, 720c malfunctions and cannot transmit measured conditions to the fire suppression apparatus 700b.

In another example, as shown in FIG. 7C, a fire suppression system 700c is shown including two fire suppression apparatuses 710c, 710d and one remote sensor device 720d. In this example, the remote sensor device 720d communicates measured conditions of the outdoor environment to the fire suppression apparatuses 710c, 710d.

In some cases, the remote sensor device 720d may communicate measured conditions to both the fire suppression apparatuses 710c, 710d. The fire suppression apparatuses 710c, 710d may activate if it determined that the measured conditions received from the remote sensor device 720d exceeds a predetermined threshold. In other cases, the remote sensor device may, for example, selectively communicate measured conditions to fire suppression apparatus 710c but not to fire suppression apparatus 710d, or vice versa. In such cases, fire suppression apparatus 710c may activate if it is determined that the measured conditions received from the remote sensor device 720d exceed a predetermined threshold, but the fire suppression 710d may remain inactive.

In another example, as shown in FIG. 7D, a fire suppression system 700d is shown including two fire suppression apparatuses 710e, 710f and two remote sensor devices 720e, 720f. In this example, the remote sensor devices 720e, 720f, communicate measured conditions of the outdoor environment to the fire suppression apparatuses 710e, 710f.

In some cases, the remote sensor devices 720e, 720f, may communicate measured conditions to both the fire suppression apparatuses 710e, 710f. The fire suppression apparatuses 710e, 710f, may activate if it is determined that the measured conditions received from the remote sensor devices 720e, 720f exceed a predetermined threshold. In other cases, one remote sensor device 720 may only communicate with its respective fire suppression apparatus 710. For example, a first remote sensor device 720e may only communicate with a first fire suppression apparatus 710e and a second remote sensor device 720f may only communicate with the second fire suppression apparatus 710f. In this example, even if the first remote sensor device 720e measures conditions that may exceed a predetermined threshold for activating the first fire suppression apparatus 710e, the second fire apparatus 710f may not necessarily activate, as the second fire suppression apparatus 710f does not receive measured conditions from the first remote sensor device 720e.

Although fire suppression systems 700 are shown with only up to two fire suppression apparatuses 710 and two remote sensor devices 720, it will be understood that any number of fire suppression apparatuses 710 and remote sensor devices 720 may be implemented to enable a fire suppression system 700. It will be further understood that any number of fire suppression apparatuses 710 and remote sensors 720 may be used in combination to enable a fire suppression system 700.

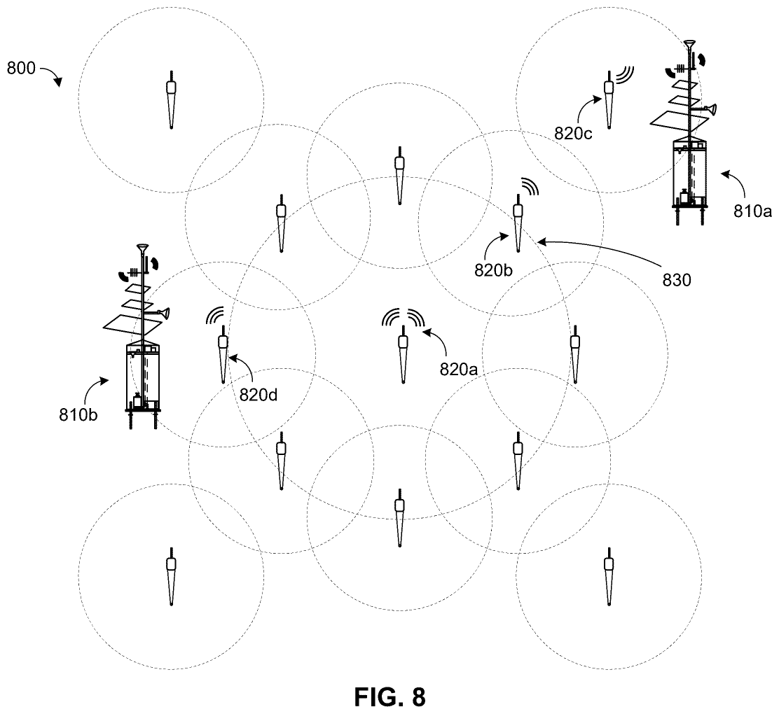

Referring now to FIG. 8, which shows a fire suppression system network according to an example embodiment.

In the illustrated example, a fire suppression system network 800 is shown including multiple remote sensor devices 820 communicating with multiple fire suppression apparatuses 810. In some embodiments, the network device of at least one remote sensor device 820 includes a mesh networking device. In this example, the fire suppression system network 800 includes a remote sensor device 820a which measures conditions of the outdoor environment within a radius 830. The remote sensor device 820a communicates with other remote sensor devices 820b, 820c, 820d (as well as other remote sensor devices not labelled) that overlap within the radius 830. Each remote sensor device 820 shown in the illustrated example may communicate with other remote sensor devices 820 or fire suppression apparatus 810, thereby creating a fire suppression system network 800.

In some examples, the fire suppression system network 800 includes a remote sensor device 820a which is an active device and the other remote sensor devices 820b, 820c, 820d which are passive devices. In this case, the passive devices do not measure conditions of the outdoor environment but may propagate the measured conditions from the active remote sensor device 820a to other passive remote sensor devices and to fire suppression apparatuses 810. For example, the active remote sensor device 820a may measure conditions of the outdoor environment that a fire suppression apparatus 810 may determine exceeds a predetermined threshold required to trigger activation. The active remote sensor device 820a may propagate the measured conditions to passive remote sensor device 820b, which then propagates the measured conditions to passive remote sensor device 820c, which then propagates the measured conditions to fire suppression apparatus 810a, thereby triggering the activation of the fire suppression apparatus 810a. In the same way the active remote sensor device 820a may propagate the measured conditions to passive remote sensor device 820d, which then propagates the measured conditions to fire suppression apparatus 810b, thereby triggering the activation of the fire suppression apparatus 810b. This may enable a preemptive operation of the fire suppression apparatus 810 before a fire detected by remote sensor device 820a within the radius 830 spreads to the areas surrounding the fire suppression apparatuses 810.

In other examples, all the remote sensor devices 820 in the fire suppression system network 800 are active remote sensors. In this case, each remote sensor device 820 may measure conditions of the outdoor environment and communicate these measured conditions with the other remote sensor devices 820 and to fire suppression apparatuses 810 of the fire suppression system network 800. For example, the remote sensor device 820b may measure conditions of the outdoor environment that a fire suppression apparatus 810 may determine exceeds a predetermined threshold required to trigger activation. The remote sensor device 820b may propagate the measured conditions throughout the fire suppression system network 800 and trigger the activation of the fire suppression apparatus 810.

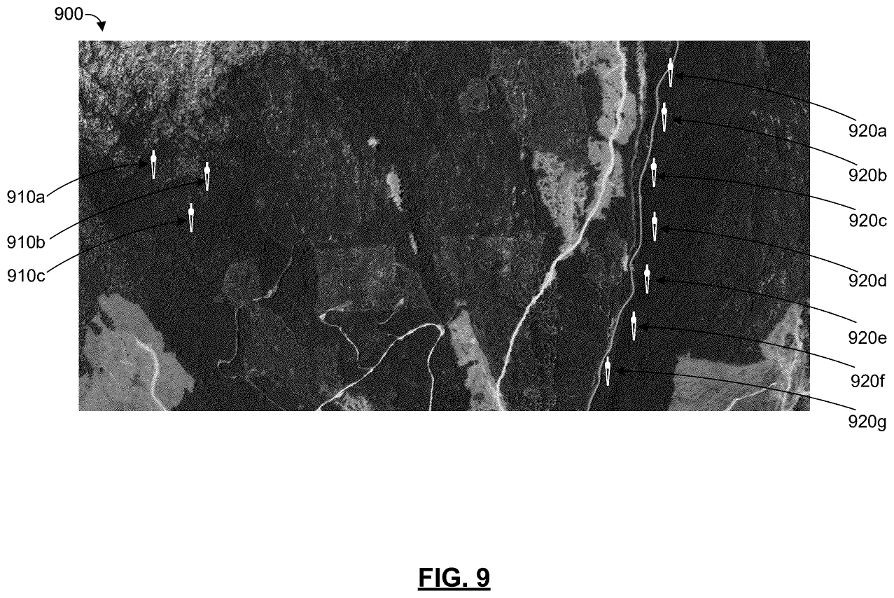

Referring now to FIG. 9, which shows an example implementation of a fire suppression system network.

The illustrated example shows a screenshot of an aerial view of a wooded area near Kelowna, British Columbia. In the illustrated example, a fire suppression system network 900 is shown implemented on large scale. The fire suppression system network 900 includes fire suppression systems 910, 920. The fire suppression apparatus within the fire suppression systems 910, 920 may operate as standalone units or with the other fire suppression apparatus units within their respective fire suppression apparatus systems 910, 920. In some examples, the fire suppression systems 910, 920 may be separate fire suppression system networks or the same fire suppression system network.

For example, the fire suppression system 910 may have fire suppression apparatuses 910a, 910b, 910c located within a forest. When a fire is detected by one of the fires suppression apparatuses 910a, 910b, 910c within the fire suppression system 910, in some cases, all other fire suppression apparatuses within the fire suppression system 910 may be activated.

In another example, the fire suppression system 920 may have fire suppression apparatus 920a, 920b, 920c, 920d, 920e, 920f, 920g located within the forest along the edge of a road. When a fire is detected by one of the fire suppression apparatuses 920a, 920b, 920c, 920d, 920e, 920f, 920g, in some cases, all other fires suppression apparatus within the fire suppression system 920 may be activated to form a fire wall to protect the nearby road.

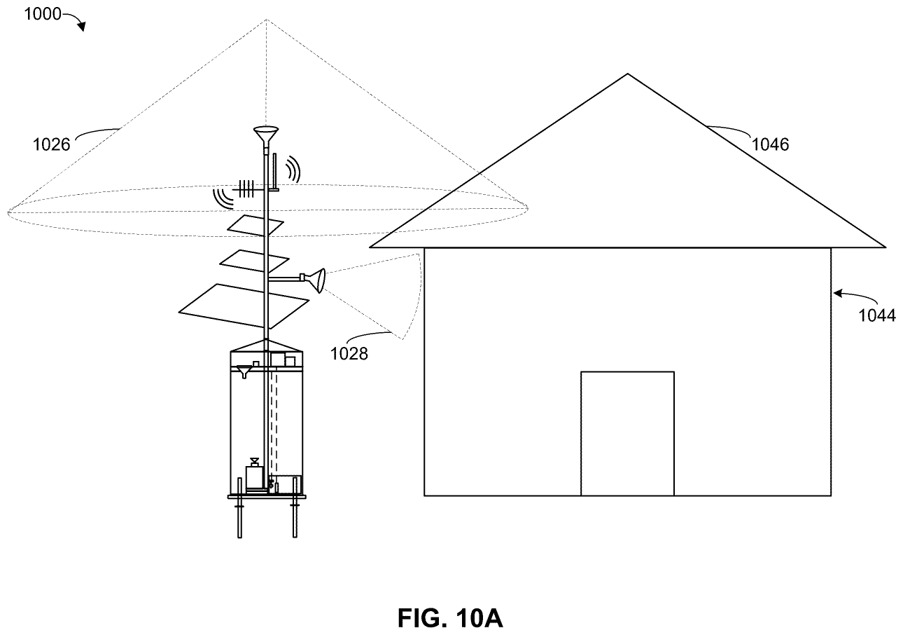

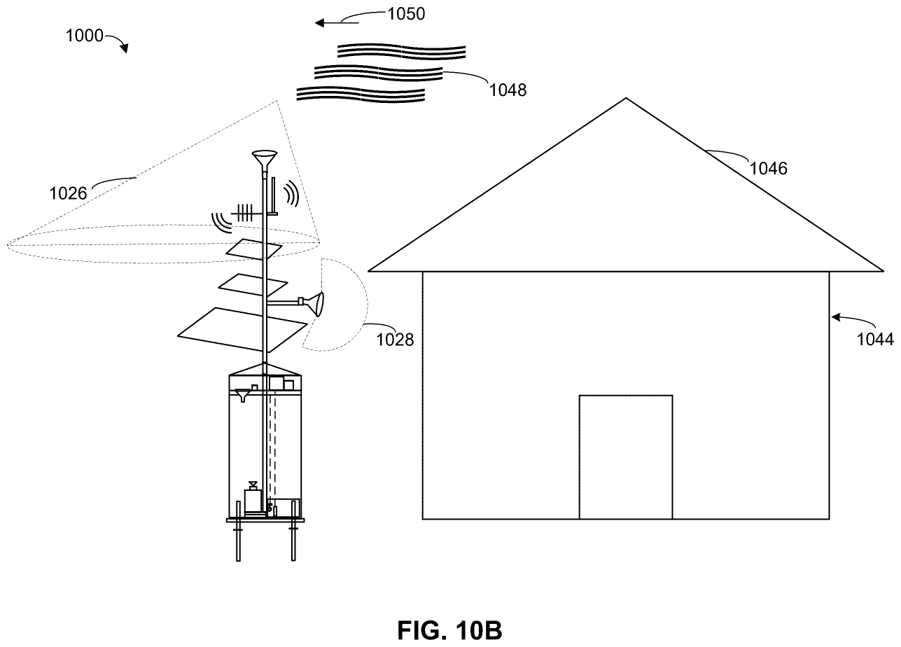

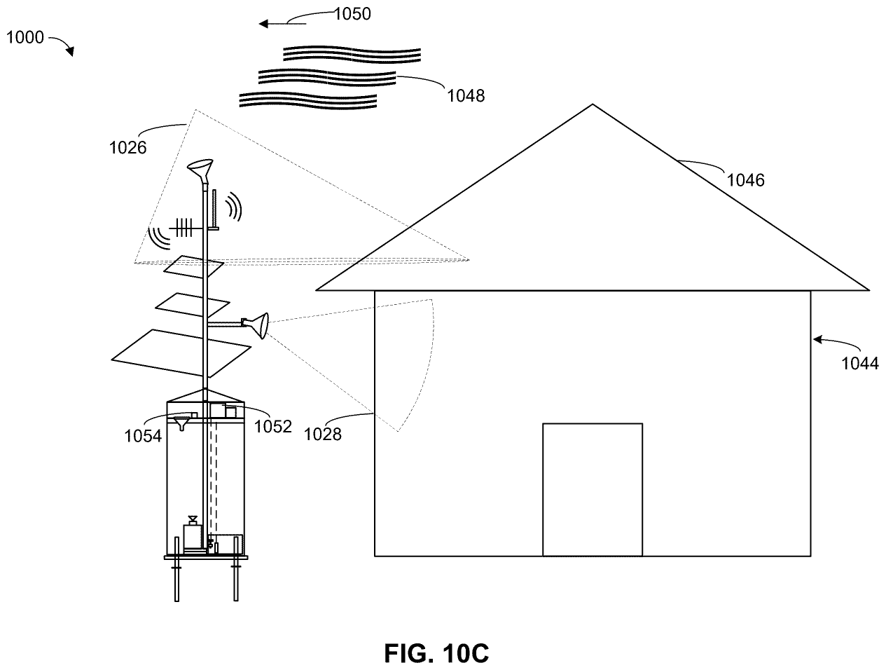

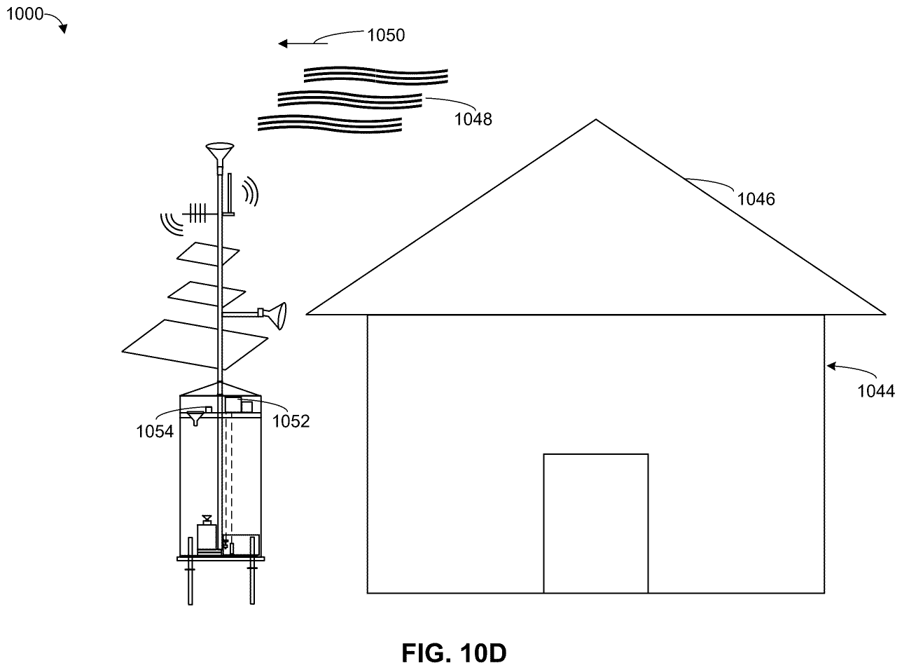

Referring now FIGS. 10A 10B, 10C, and 10D, which show example illustrations of a fire suppression apparatus in operation during different weather conditions.

In FIG. 10A, the fire suppression apparatus 1000 is shown spraying fire retardant on a house 1044. The fire suppression apparatus 1000 sprays a first spray field 1026 which covers the roof 1046 of the house 1044 with fire retardant and a second spray field 1028 which covers the side of the house, under the eaves of 1044 with fire retardant.

In FIG. 10B, the fire suppression apparatus 1000 is shown spraying fire retardant towards a house 1044. In the illustrated example, the first spray field 1026 and the second spray field 1028 do not reach the house because wind 1048 is blowing in a direction 1050 away from the house. The wind 1048 carries the fire retardant sprayed from the fire suppression apparatus 1000 away from the house, disrupting the operation of the fire suppression apparatus 1000.

In FIG. 10C, the fire suppression apparatus 1000 is shown responding to the windy conditions shown in FIG. 10B. In some embodiments, the fire suppression apparatus 1000 may include a wind speed sensor 1052 and a wind direction sensor 1054 to measure the wind conditions 1048 surrounding the fire suppression apparatus 1000. The wind sensors may be, for example, cup anemometers, vane anemometers, or sonic anemometers.

The wind speed sensor 1052 and the wind direction sensor 1054 may determine the operation of the fire suppression apparatus 1000. As described above, windy conditions, blowing in a direction away from the house 1044 may prevent the fire retardant sprayed from the fire suppression apparatus 1000 from reaching the house 1044. At the same time, prevailing winds 1048 blowing in the same direction 1050 may carry an oncoming fire towards the house 1044 more rapidly. In some embodiments, the fire suppression apparatus 1000 includes a processor (not shown) configured to adjust the activation signal to change at least one from the group of a spray angle, a spray field, and a flow rate of the retardant distribution means based on a wind speed signal from the wind speed sensor 1052 or a wind direction signal from a wind direction sensor 1054.

For example, as shown in the example illustration, the processor may adjust the activation signal to change the spray angle of the first spray field 1026 and flow rate of the retardant distribution means based on received signals from the wind speed sensor 1052 and the wind direction sensor 1054 to ensure that the spray fields 1026, 1028 reach the house 1044 despite the windy conditions.

In FIG. 10D, the fire suppression apparatus 1000 is shown responding to the windy conditions shown in FIGS. 10B and 10C. In the illustrated example, the processor may determine that, based on the received wind signals from the wind speed sensor 1052 and the wind direction sensor 1054, no level of adjustment to the spray angle, the spray field, or the flow rate may ensure that the fire retardant reaches the house 1044. In such cases, the processor may determine to halt the operation of the fire suppression apparatus 1000 until the windy conditions subside. In this way, no fire retardant is wasted.

In some embodiments, the processor records the windy conditions measured by the wind speed sensor 1052 and the wind direction sensor 1054. In some examples, a record of the windy conditions may serve form of risk mitigation, showing reasons why the fire suppression apparatus 1000 was not operating during certain times or why the fire suppression apparatus 1000 not operating at peak effectiveness.

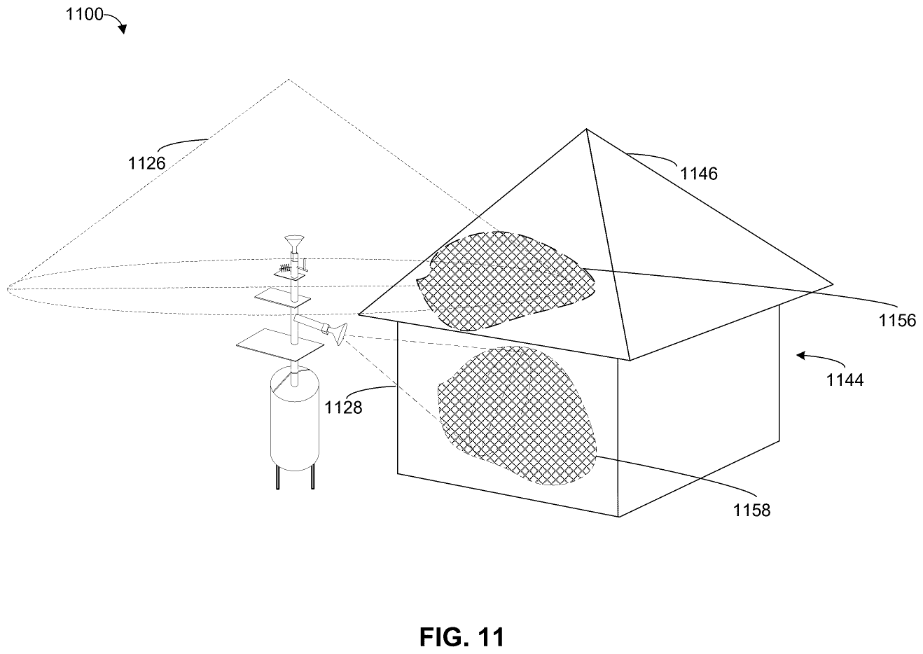

Referring now to FIG. 11, which shows a perspective view of a fire suppression apparatus in operation according to an example embodiment.

In FIG. 11, the fire suppression apparatus 1100 is in operation spraying fire retardant on a house 1144. The fire suppression apparatus 1100 has a first spray field 1126 to cover the roof 1146 of the house 1144 and a second spray field 1128 to cover the side of the house 1144 below the eaves. When applied to the house 1144, the first spray field 1126 leaves a fire suppressant coating 1156 on the roof 1146 of the house 1144 and the second spray field 1128 leaves a coating fire suppressant coating 1158 on the side of the house 1144 below the eaves. The fire suppressant coatings 1156, 1158 are shown for as hatched areas for illustrative purposes only. It will be understood that the fire suppressant coating patterns 1156, 1158 may vary depending on the positioning of the fire suppression apparatus 1100 with respect to the house 1144, the spray angle and flow rate of the fire suppression apparatus, and the weather conditions in the area surrounding the house, or any combination of these.

Applying a fire suppressant coating 1156, 1158 may reduce the risk of a fire. The fire suppressant coating 1156, 1158 acts as a protective layer on the surface they are applied to, by preventing the fuel from reaching ignition temperature and hindering a fire's progress. For example, some fire retardants release water or gases (e.g., carbon dioxide) when heated, creating a barrier between the fire and the fuel.

As described above, using a user adjustment means, the spray fields 1126, 1128 may be adjusted to strategically apply a fire suppressant coating 1156, 1158 to the house 1144. Generally, implementing a first spray field 1126 and a second spray field 1128 maximizes the coverage fire suppressant coating 1156, 1158 on the house 1144. The first spray field 1126 applies a fire suppressant coating 1156 over a wide range (e.g., on the roof and on the surrounding foliage) while the second spray field 1128 can apply a fire suppressant coating 1158 in a targeted approach, generally to cover areas that cannot be reached by the first spray field 1126 (e.g., below the eaves).

In some examples, the spray fields 1126, 1128 may be adjusted to service a wider or more targeted range. For example, the first spray fields 1126 may be adjusted from a 360 degree angle, as shown in the illustrated example, to a 180 degree angle directed toward the house 1144 to minimize wasted fire retardant. The second spray field 1128 may be adjusted from a narrow spray field to a wide spray field to increase the size of the fire suppressant coating 1158, for example, beyond the side of the house 1144 to cover the area in front of the wall of the house 1144.

In other examples, the angle of the sprays field 1126, 1128 may be adjusted to direct a larger portion of the fire retardant exiting the spray heads towards the house 1144. In other words, the angle of the spray heads may be adjusted so that when the angle of ejection is aimed more directly toward the house. This may increase the size of the fire suppressant coatings 1156, 1158 and maximize the use of fire retardant.

In still other examples, the flow rate of the spray fields 1126, 1128 may be adjusted to apply a fire suppressant coating 1156, 1158 to the house 1144 more quickly. This may be useful in critical situations when a fire is detected nearby the house 1144, or when windy conditions disrupt the operation of the fire suppression apparatus 1100, as described above with respect to FIG. 10C.

In some embodiments, as described above, a drone (not shown) may be used to apply a fire suppressant coating to the house 1144. The drone may fly within a radius of the fire suppression apparatus 1100 and apply a fire suppressant coating to areas that were not covered by the first spray field 1126 or the second spray field 1128 as a touchup. In other cases, the drone may be used to apply fire suppressant coating to critical areas surrounding the house 1144 such as foliage, entrances, and vehicles, where the spray heads of the fire suppression apparatus 1100 are not aimed at.

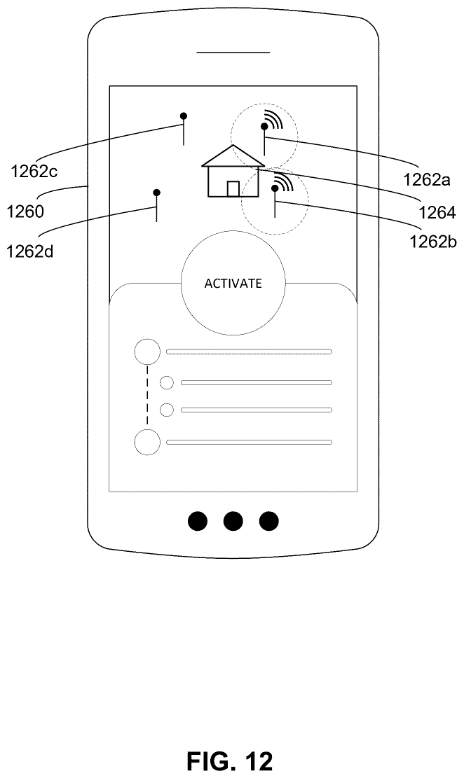

Referring now to FIG. 12, which shows an activation system on a user device according to an example embodiment.

In FIG. 12, a user device 1260 is shown for monitoring and controlling the operation of a fire suppression system with fire suppression apparatuses 1262. The user device may have a mobile application with a graphical user interface (GUI) that a user may interact with to monitor and control the fire suppression system. In some examples, the GUI may display the locations of the fire suppression apparatus around a house 1264. The user may use the mobile application to activate the one or more fire suppression apparatuses 1262 in the fire suppression system by interacting with the GUI. As shown in the illustrated example, fire suppression apparatus 1262a and fire suppression apparatus 1262b are active while fire suppression apparatus 1262c and fire suppression apparatus 1262d are inactive.

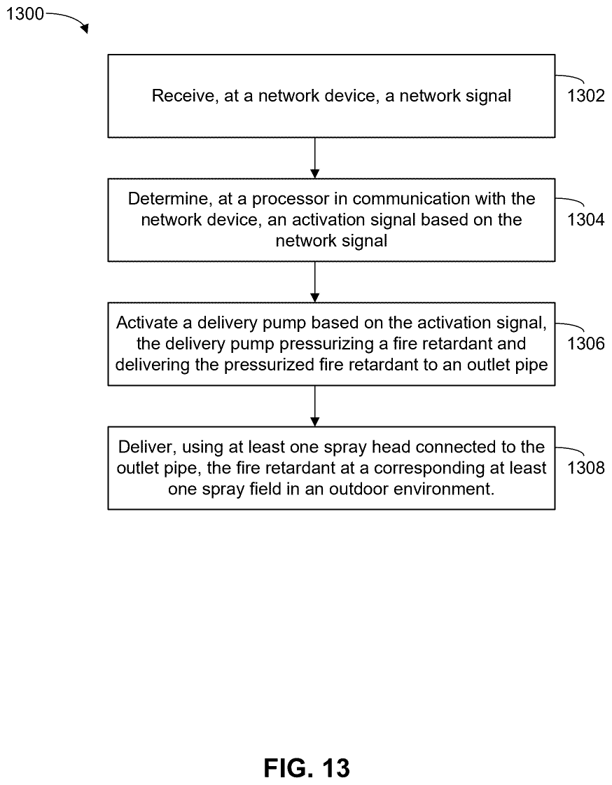

Referring now to FIG. 13, which shows a method diagram for suppression in accordance with one or more embodiments.

At 1302 a fire suppression system receives, at a network device 142 a network signal. In some embodiments, the network device 142 is a wired network device.

The network device 142 may be, for example, part of the communication system 140 described above with reference to FIG. 1B. In some embodiments, the network device 142 may be a wired network device. In some embodiments, the network device 142 may be a wireless network device. In some embodiments, the network signal may be received from a user device. In some embodiments, the network signal may be received from a remote sensor device. In some embodiments, the remote sensor device may be part of a sensor system described above with reference to FIG. 1A.

At 1304, the fire suppression system determines, at a processor in communication with the network device, an activation signal based on the network signal.

In some examples, the activation signal may be generated by a processor and transmitted to an activation system via a communication system as described above in with reference to FIG. 1A.

At 1306, the fire suppression system activates a delivery pump based on the activation signal, the delivery pump pressurizing a fire retardant and delivering the pressurized fire retardant to an outlet pipe.

In some embodiments the method may include activating a fire suppression apparatus to deliver, at a first spray head connected to an outlet pipe, fire retardant at a first spray field in an outdoor environment as described above with reference to FIG. 2A. In some embodiments, the method may include engaging a fire suppression apparatus to deliver, at a second spray head connected to an outlet pipe, fire retardant at a second spray field in an outdoor environment as described above with reference to FIG. 2A.

In some embodiments, the method may include activating a delivery pump means, described above with reference to FIG. 2A (see e.g., 210) to generate a first spray field that is relative to a radial direction of the outlet pipe and a second spray field that is relative to a length direction of an outlet pipe.

In some embodiments, the method may include activating a delivery pump means, described above with reference to FIG. 2A (see e.g., 210), to generate a first spray field that is 360 degrees relative to the radial direction of the outlet pipe and a second spray field that is 90 degrees relative to the direction of the outlet pipe.

In some embodiments, the method may include engaging a delivery pump means, described above with reference to FIG. 2A (see e.g., 210), to generate a first spray field that extends 180 degrees relative to the radial direction of the outlet pipe and a second spray field that extends 45 degrees relative to the length direction of the outlet pipe.

At 1308 the fire suppression system delivers, using at least one spray head connected to the outlet pipe, the fire retardant at a corresponding at least one spray field in an outdoor environment.

In some embodiments, the method may include a field adjustment means to adjust the first spray field of the first spray head and the second spray field of the second spray head, described above with reference to FIGS. 5A, 5B, and 5C (see e.g., 526, 528).

In some embodiments, the method may include an angular adjustment means for adjusting the first spray field of the first spray head by a first spray angle and adjusting the second spray field of the second spray head by a second spray angle, described above with reference to FIGS. 5A, 5B, and 5C (see e.g., 534).

In some embodiments, the method may include a flow rate adjustment means for adjusting a flow rate of the fire retardant into the first spray field and a flow rate of the fire retardant into the second spray field, described above with reference to FIGS. 5A, 5B, and 5C (see e.g., 534).

In some embodiments, the method may include a fire retardant that may be one of a liquid, a foam mixture, or a gel, as described above with reference to FIG. 2A (see e.g. 206). In some embodiments, the fire retardant may be PHOS-CHEK®.

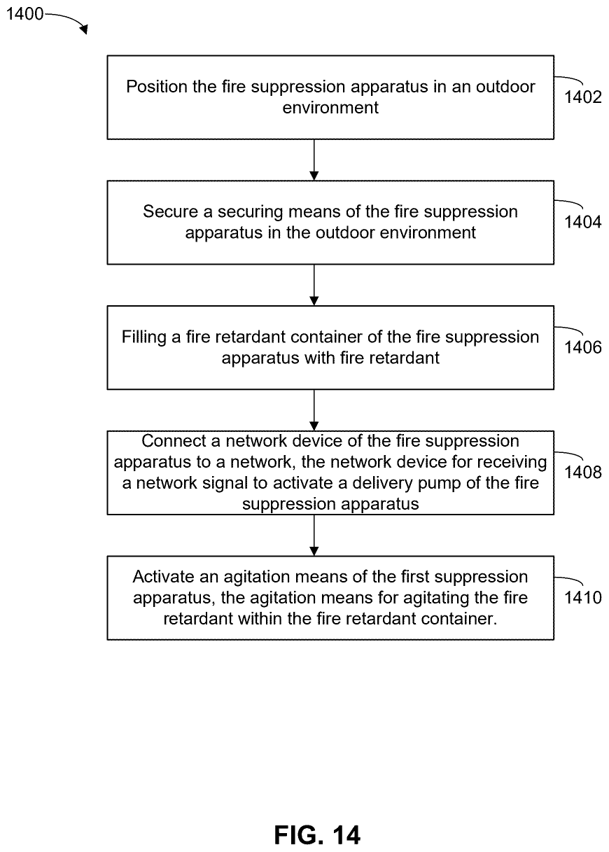

Referring now to FIG. 14, which shows a method diagram for installing a fire suppression apparatus in accordance with one or more embodiments.

At 1402, the fire suppression apparatus is positioned in an outdoor environment. In some embodiments, the fire suppression may be positioned in an outdoor environment such as described above with reference to FIG. 2A (i.e., on the side of a mountain or within a remote wooded area). Alternatively, or in addition, the fire suppression apparatus may be strategically placed in an outdoor environment along other fires suppression apparatuses to form a fire suppression system or a fire suppression network as described above with reference to FIG. 9.

At 1404, fire suppression apparatus is secured in an outdoor environment via a securing means.

The fire suppression apparatus may be secured in an outdoor environment using securing means, as described above with reference to FIG. 2A (see e.g., 202).

At 1406, the fire suppression apparatus is filled with fire retardant container fire retardant.

In some embodiments, the method includes fire retardant that may be a mixture of water and fire retardant concentrate. In some embodiments, the method includes fire retardant concentrate that may be a mineral-based fire retardant, as described above with reference to FIG. 2A (see e.g., 206).

At 1408, a network device of the fire suppression apparatus is connected to a network. The network device receives a network signal to activate the delivery pump of the fire suppression apparatus.

In some embodiments, the network device is a wired network device. In some embodiments the network device is a wireless network device, described above with reference to FIG. 1B.

At 1410, an agitation means of the fire suppression apparatus is activated. The agitation means agitates the fire retardant within the fire retardant container as described above with reference to FIG. 4 (see e.g., 408).

The present invention has been described here by way of example only. Various modification and variations may be made to these exemplary embodiments without departing from the spirit and scope of the invention, which is limited only by the appended claims.

1. A fire suppression apparatus, comprising:
a securing means for securing the fire suppression apparatus in an outdoor environment;
a retardant container connected to the securing means for storing fire retardant;
an agitation pump means, the agitation pump providing agitation of the fire retardant within the retardant container;
a delivery pump, an inlet of the delivery pump in communication with the fire retardant in the retardant container, wherein when activated, the delivery pump delivers pressurized fire retardant at an outlet of the delivery pump;
an outlet pipe connected to the outlet of the delivery pump; and
at least one spray head receiving the pressurized fire retardant from the outlet pipe and delivering fire retardant in a corresponding at least one spray field in the outdoor environment.

2. The fire suppression apparatus of claim 1, further comprising:
a first spray head in the at least one spray head connected to the outlet pipe, the first spray head having a first spray field, the first spray head receiving the pressurized fire retardant from the outlet pipe and delivering fire retardant in the first spray field in the outdoor environment; and
a second spray head in the at least one spray head connected to the outlet pipe, the second spray head having a second spray field different from the first spray field, the second spray field receiving the pressurized fire retardant from the outlet pipe and delivering fire retardant at the second spray field in the outdoor environment.

3. The fire suppression apparatus of claim 2, wherein the delivery pump is submerged in the fire retardant.

4. The fire suppression apparatus of claim 3, further comprising:
an electrical storage means; and
wherein the agitation pump and the delivery pump are electric pumps powered by the electrical storage means.

5. The fire suppression apparatus of claim 4, further comprising:
a solar panel for charging the electrical storage means.

6. The fire suppression apparatus of claim 1, further comprising a remote device for activating the delivery pump.

7. The fire suppression apparatus of claim 2, wherein the first spray field is relative to a radial direction of the outlet pipe and the second spray field is relative to a length direction of the outlet pipe.

8. The fire suppression apparatus of claim 7, wherein the first spray head and the second spray head each comprise a user adjustment means operable by a user.

9. The fire suppression apparatus of claim 1, wherein the fire retardant is a mixture of water and fire retardant concentrate.

10. The fire suppression apparatus of claim 9, wherein the fire retardant concentrate is a mineral-based fire retardant.

11. A fire suppression system, comprising:
a network device for receiving a network signal;
a fire retardant container for receiving fire retardant;
an activation means for controlling a delivery pump connected to the fire retardant container;
a retardant distribution means connected to the delivery pump for distributing fire retardant in an outdoor environment;
a processor in communication with the network device and the activation means, the processor configured to:
determine an activation signal based on the network signal; and
transmit the activation signal to the activation means to activate the delivery pump and distribute fire retardant via the retardant distribution means.

12. The fire suppression system of claim 11 wherein the network device is a wireless network device.

13. The fire suppression system of claim 12, further comprising:
a remote sensor device, the remote sensor device comprising a network device for transmitting the network signal to the network device, the network signal comprising at least one selected from the group of an air temperature measurement, a ground temperature measurement, an ozone measurement, a relative humidity measurement, a soil moisture measurement, an air particulate measurement, and a carbon monoxide measurement.

14. The fire suppression system of claim 13, further comprising at least two remote sensor devices wherein the network device of each of the at least two remote sensor devices comprises a mesh networking device.

15. The fire suppression system of claim 12, wherein the processor is further configured to adjust the activation signal to change at least one selected from the group of: a spray angle, a spray field, and a flow rate of the retardant distribution means based on the activation signal.

16. A method of installing a fire suppression apparatus, comprising:
positioning the fire suppression apparatus in an outdoor environment;
securing a securing means of the fire suppression apparatus in the outdoor environment;
filling a fire retardant container of the fire suppression apparatus with fire retardant;
connecting a network device of the fire suppression apparatus to a network, the network device for receiving a network signal to activate a delivery pump of the fire suppression apparatus; and
activating an agitation means of the first suppression apparatus, the agitation means for agitating the fire retardant within the fire retardant container.

17. The method of claim 16, further comprising:
installing a remote sensor device in the vicinity of the fire suppression apparatus; and
configuring a network device of the remote sensor device to connect to the network device of the fire suppression apparatus.

18. The method of claim 16 wherein the network device is a wireless network device.

19. The method of claim 16, wherein the fire retardant is a mixture of water and fire retardant concentrate.

20. The method of claim 19, wherein the fire retardant concentrate is a mineral-based fire retardant.
